(19) United States
(12) Patent Application Publication
(10) Pub. No.: US 2002/0140898 A1
(43) Pub. Date: Oct. 3, 2002

(54) Single eyeglasses lens and a metal frame

(76) Inventor: Bi-Cheng Wu, Tainan (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/824,597

(22) Filed: Apr. 2, 2001

(51) Int. Cl. G02C 1/00

(52) U.S. Cl. 351/83

(57) ABSTRACT

A single eyeglasses lens and a metal frame includes a single eyeglasses lens having a center hole for a center projection of a metal frame to fit firmly therein, and two grooves formed in two opposite sides to engage with two projections formed in two ends of an intermediate portion of the metal frame to assemble with the single eyeglasses lens stably and elastically without using no screws. The metal frame is made of a light and flexible metal, having two ends connected to two temples able to be expanded outward and bent inward.

### BACKGROUND OF THE INVENTION

This invention relates to a single eyeglasses lens and a metal frame, particularly to one having a single eyeglasses lens of various shapes to be combined with a metal frame having a very light weight and extremely good elasticity to keep firmly the single lens having an intermediate hole and a groove respectively at two sides so as to quickly assemble the single eyeglasses lens with the metal frame with no screws used, without any fear of any screws falling off.

A conventional single eyeglasses lens is generally combined with a plastic frame provided with a elongate groove formed in a lower edge so as to fit the single lens therein and assembled with two temples with screws, with potential possibility of the screws falling off the lens frame to let the temple separate from the lens frame.

### SUMMARY OF THE INVENTION

The objective of the invention is to offer a single eyeglasses lens and a metal frame of a very lightweight and excellent elasticity to be combined with the single lens with easiness and quickness. The metal frame has a first projection formed to bend backward in an intermediate portion, a second projection formed respectively in two sides, and the two second projections continuously formed respectively with a direction limit member and connected to a front curved end of each temple. The single eyeglasses lens has a hole in the center portion for the first projection of the metal frame to engage therein, and a second projection at two sides of the metal frame engaging respectively with a groove at two sides of the single eyeglasses lens, finishing assembly of the single lens and the metal frame, with the single lens kept stably by the metal frame.

A second objective of the invention is to offer a metal frame having an intermediate portion smooth without any projections to fit in a groove between two parallel projections formed on a center point of an upper portion of the single eyeglasses lens.

A third objective of the invention is to offer a single eyeglasses lens having a center hole in an upper portion, and an engage button formed to have a round body and a flange and a deep center slot to fit firmly in the center hole of the single eyeglasses lens to compress an intermediate portion of the metal frame in the deep center slot and push against the single eyeglasses lens so as to assemble the single eyeglasses lens with the metal frame stably.

### BRIEF DESCRIPTION OF DRAWINGS

This invention will be better understood by referring to the accompanying drawings, wherein:

FIG. 1 is a perspective view of a single eyeglasses lens and a metal frame in the present invention:

FIG. 2 is a perspective view of the single eyeglasses lens combined with the metal frame in the present invention:

FIG. 3 is an upper view of the single eyeglasses combined with the metal frame in the present invention, showing two temples being bent inward for collapsing the metal frame:

FIG. 4 is a side view of combining parts of the single eyeglasses lens and the metal frame in the present invention:

FIG. 5 is a cross-sectional view of the line I-I in FIG. 4:

FIG. 6 is a cross-sectional view of the line II-II in FIG. 4:

FIG. 7 is a perspective view of a first embodiment of a single eyeglasses lens and a metal frame in the present invention:

FIG. 8 is a perspective view of a second embodiment of a single eyeglasses lens and a metal frame in the present invention:

FIG. 9 is a perspective view of a third embodiment of a single eyeglasses lens and a metal frame in the present invention: and,

FIG. 10 is a cross-sectional view of the third embodiment of a single eyeglasses lens and a metal frame in the present invention.

### DETAILED DESCRIPTION OF THE PREFERRED EMBODIMENTS

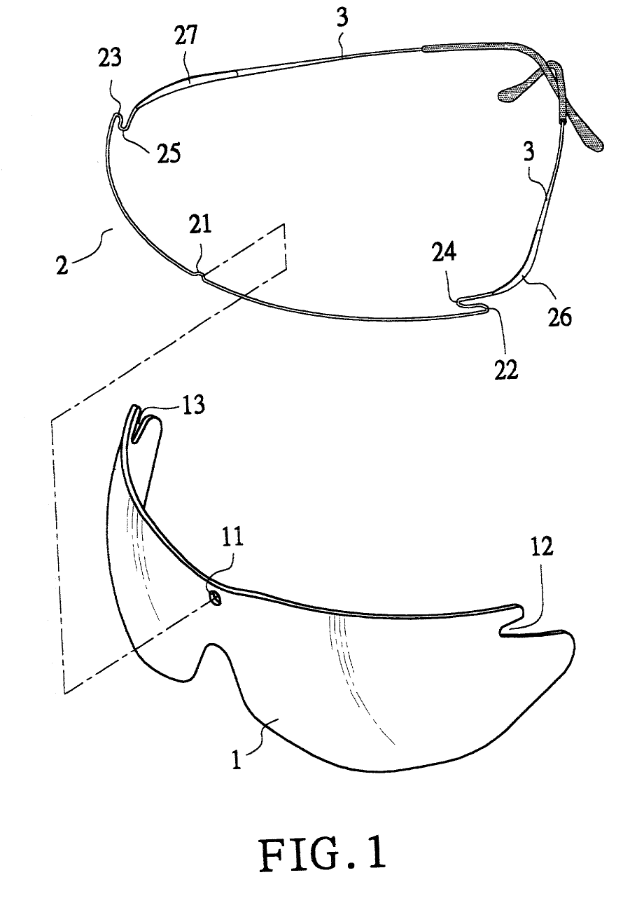

A first embodiment of a single eyeglasses lens and a metal frame in the present invention, as shown in FIG. 1, includes a single eyeglasses lens 1 and a lens frame 2 as main components.

The single eyeglasses lens 1 has a center hole 11 bored near an upper side in an intermediate portion, and a groove 12, 13 formed respectively in two opposite ends of the upper side.

The metal frame 2 is made of a light and comparatively elastic metal, having two opposite ends connected to two temples 3 integrally, as shown in FIG. 6, a first projection 21 formed to bend backward in a middle point, two projections 22, 23 formed in two opposite sides and two grooves 24, 25 formed respectively between the two projections 22, 23 and two inner curved ends 26, 27 of the two temples 3, as shown in FIG. 5.

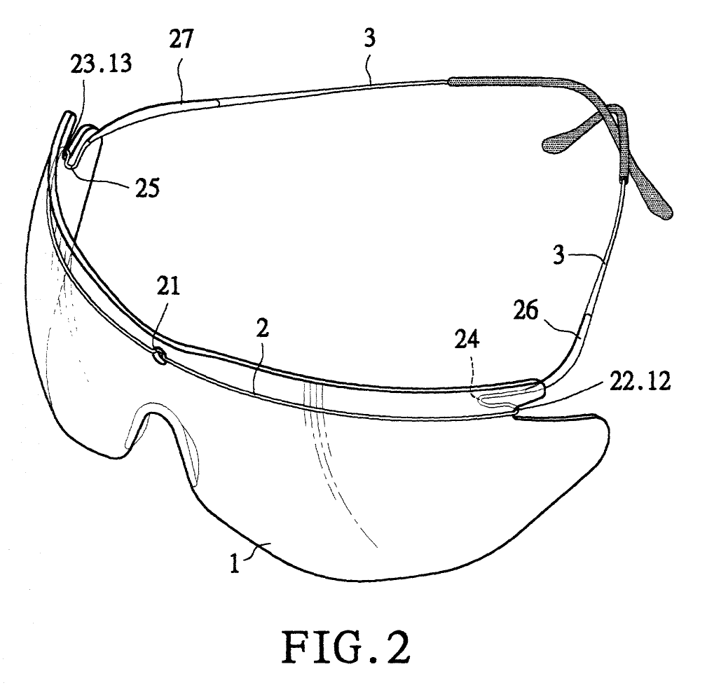

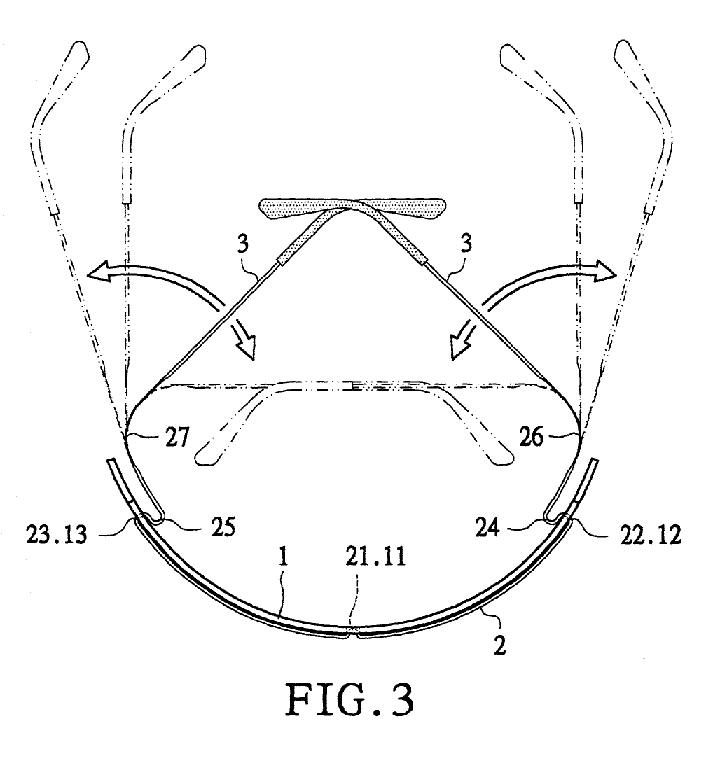

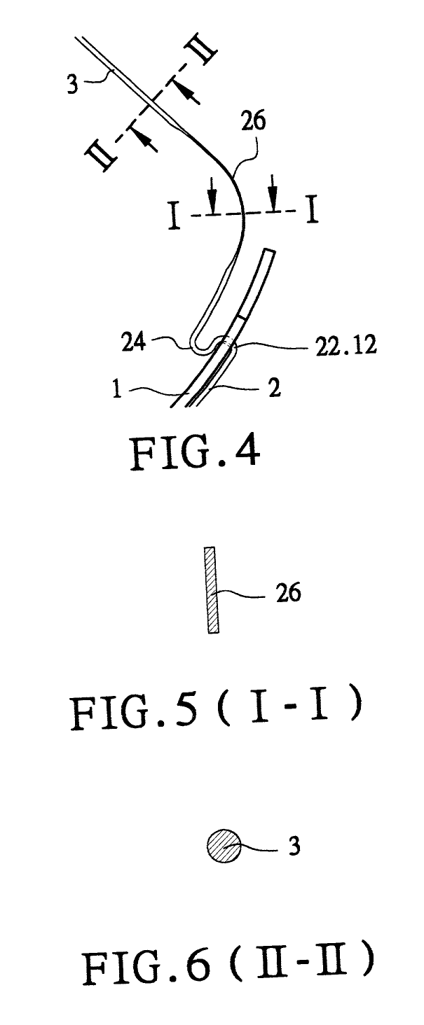

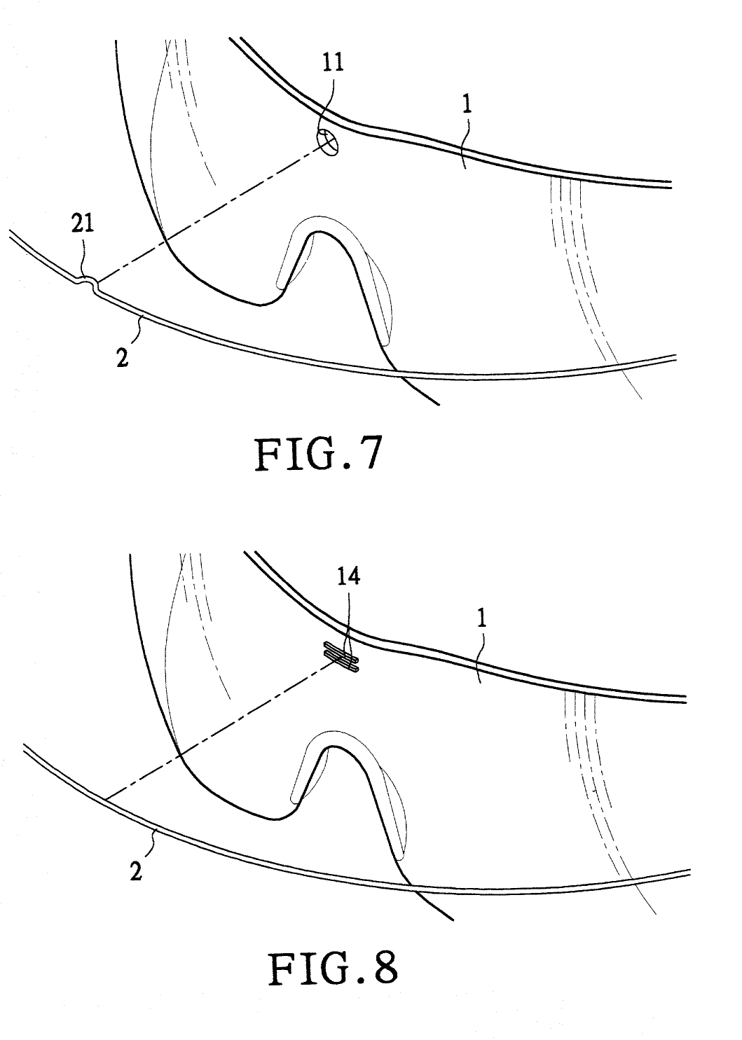

In assembling, referring to FIGS. 2 and 7, firstly the first projection 21 is inserted in the center hole 11 of the single eyeglasses lens 1, with the second projections 22, 23 respectively engaging with the grooves 12, 13 with proper tightness, as shown in FIGS. 3 and 4. Then the single eyeglasses lens 1 and the metal frame 2 are assembled together integrally and stably, with the whole weight of the pair of eyeglasses being very light. Then the two temples 3 may be expanded outward or bent inward by means of the two curved and elastic ends 26, 27 of the two temples 3, as shown in FIG. 3.

Further, a second embodiment of a single eyeglasses and a metal frame is shown in FIG. 8, having almost the same structure as the first embodiment except a metal frame 2 formed without the projection 21 in the first embodiment, and a single eyeglasses lens 1 formed smooth with two parallel straight projections 14 defining a middle groove to receive the middle section of the metal frame 2 so as to assemble the single eyeglasses lens 1 with the metal frame.

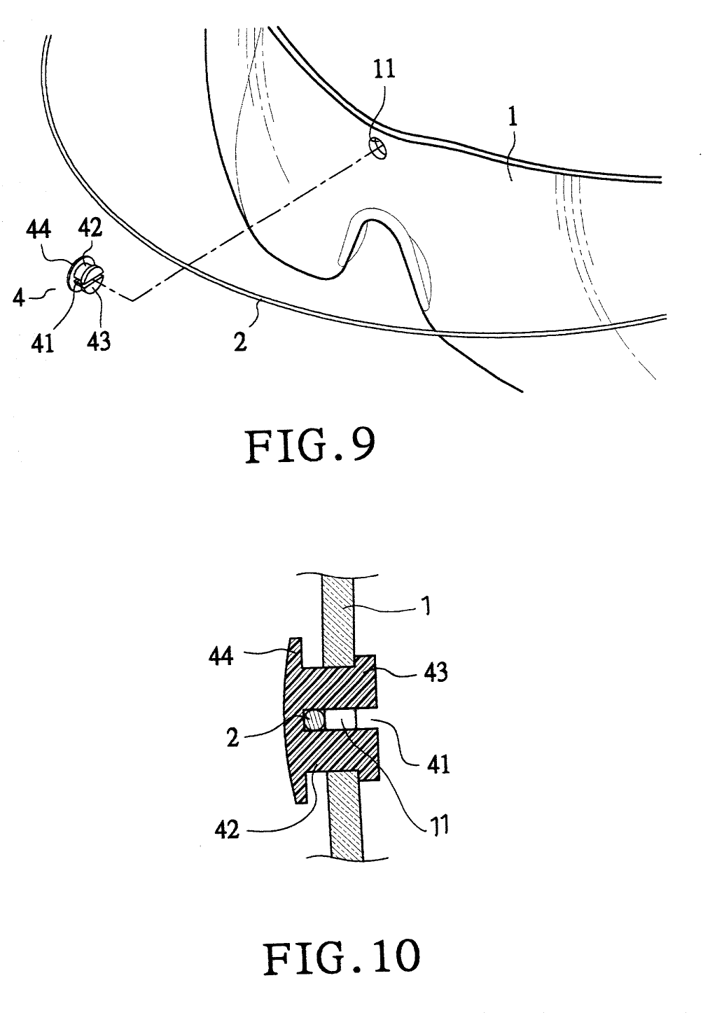

Then a third embodiment of a single eyeglasses lens and a metal frame is shown in FIGS. 9 and 10, having also nearly the same structure as the first embodiment except a metal frame formed without the projection 21 in the first embodiment, and an engage button 4 made of a soft elastic material and having a center slot 41, a round body 42 of the same diameter as the hole 11 of the single eyeglasses lens 1 to fit in the center hole 11 and then compress the intermediate section of the metal frame in the slot 41 and then push against the single eyeglasses lens 1 so as to assemble the lens 1 with the metal frame 2 stably.

While the preferred embodiments of the invention have been described above, and it will be recognized that various modifications may be made therein and the appended claims are intended to cover all such modifications that may fall within the spirit and scope of the invention.

I claim:

1. A single eyeglasses lens and a metal frame comprising:
A single eyeglasses lens made integral and having a center hole bored in a middle point of an upper portion and a groove formed inward respectively in two opposite ends of said upper portion:
A metal frame made of light and very elastic metal, having a first projection formed in an intermediate portion, two second projections formed in two ends of said intermediate portion, and a groove formed respectively between each said second projection and an inner end of a temple portion, said inner end section of each said temple portion formed curved to have flexibility:
Said first projection of said metal frame fitting in said center hole of said single eyeglasses lens., said two opposite projections of said metal frame fitting with proper tightness in said two opposite grooves of said single eyeglasses lens, said single eyeglasses lens thus assembled with said metal frame stably, with each said curved end section of each said temple permitting each said temple able to be expanded outward and to be bent inward against said intermediate portion of said metal frame.

2. The single eyeglasses lens and the metal frame as claimed as claim 1, wherein said metal frame has no projections in said intermediate portion, and said singe\le eyeglasses lens has two parallel projections formed on a middle point of said upper portion for said middle section of said metal frame to fit firmly in a groove defined by said two parallel projections in assembling said single eyeglasses lens and said metal frame.

3. The single eyeglasses lens and the metal frame as claimed in claim 1, wherein an elastic button is provided to have a round body, an outer flange and a deep center slot, said elastic button fits tightly in said center hole of said single eyeglasses lens, said intermediate portion of said metal frame is compressed in said deep center slot by said elastic button and pushed firmly against said single eyeglasses lens so as to assemble said single eyeglasses lens and said metal frame.
